(19) United States
(12) Patent Application Publication
(10) Pub. No.: US 2019/0290549 A1
(43) Pub. Date: Sep. 26, 2019

(54) INFANT TEETHER WITH HYGIENIC INVERSION STORAGE METHOD

(71) Applicant: Hashtag Kidz LLC, Lake Oswego, OR (US)

(72) Inventors: Haiting Qi, Lake Oswego, OR (US); Tun Zhou, Lake Oswego, OR (US)

(21) Appl. No.: 16/437,022

(22) Filed: Jun. 11, 2019

Related U.S. Application Data
(63) Continuation of application No. 16/350,368, now abandoned.

(30) Foreign Application Priority Data
Nov. 14, 2017 (CN) 201721511576.X

(51) Int. Cl. A61J 17/02

(52) U.S. Cl. CPC A61J 17/02

(57) ABSTRACT

A baby teether having a means to invert inside out is disclosed. The invention comprised of a hollow, slightly flexible material such as silicone, rubber and the like having a plurality of shapes that can be received by an infant's mouth. Said teether also having side walls that are thinner in cross-section than all other walls and a slit aperture on one face allowing it to become inverted within itself. When ready for use, the device can be recoiled. The cavity inside the device can also be used to store small baby snacks therein. An object of the invention is to enhance infant hygiene by providing a teether that can be turned inside out thereby minimizing cross-contamination during storage.

### FIELD OF THE INVENTION

The present invention generally relates to infant accessories. More specifically, it relates to a device and method for a hygienic teether.

### BACKGROUND

Teethers, also referred to as teething toys or binkies, have been around for centuries. One of the earliest teethers was made of animal bone and some were later combined with rattles in the 1700s. In the 1800s, the europeans wrapped a lump of meat or fat inside a cloth that was sometimes moistened with brandy and others wrapped sweetened bread in cloth for teething. In the mid 1800s ring-shaped teethers made of rubber became popular and in the early 1900s Sears, Roebuck & Co. developed a teether with both hard and soft ends. With the popularity of plastic compounds, the infant industry has developed a myriad of teethers in recent years. U.S. Pat. Nos. D745283S1 and US D745283S1 granted to Phillips et. al. and Herbst respectively teaches a teether combined with a toothbrush. International Patent Nos. 2001022914A1 and 1999048460A1 granted to Badalamenti disclosed a teether having gel inserts. U.S. Patent Nos. 20090192547 and 20090299410 granted to Gates and Brabant respectively, teaches teethers that double as infant toys. U.S. Patent No. 20070288056A1 granted to Goldwire disclosed a teething mitt that, when turned inside out, becomes a pacifier. U.S. Patent No. 20040267319A1 granted to Stack teaches a bracelet teether that can be turned inside out when not in use. While teethers have become more sophisticated, none were found in the prior art that allow a parent to flip a teether inside out for hygienic, storage purposes.

### SUMMARY OF THE INVENTION

The device herein disclosed and described provides a solution to the shortcomings in the prior art through the disclosure of a hollow, infant teether with hygienic inversion storage method. An object of this invention is to ease infant discomfort during teething. The soft, chewable surface of the teether allows teeth to expedite the emergence of teeth through the gums while at the same time soothing the gums.

Another object of this invention is to enhance the hygiene of a teether during storage when not in use. When an infant is through with the teether, a parent can insert their thumbs into the aperture and squeeze the outer walls together thereby forcing the teether to become inverted. This inversion prevents the outer surfaces (now inverted) from coming into contact with other materials such as a storage container or pocket book etc. thereby minimizing the risk of any potential contamination. When ready for use, the aperture is pulled open and the teether recoils to its original shape.

Another object of this invention is to allow the invention to store small food items inside the invention. For example, the slot on the front of the invention can allow small snacks (such as Cheerios™ and the like) to be pushed through and retained inside the device. A user can then pull out the snacks or allow an infant to chew on the device thereby releasing the crushed snack in manageable portions to be eaten.

Lastly, another object of the aforementioned invention is to enhance teether mobility. When inverted, the disclosed teether is reduced to approximately one-third of its original size and can fit easily into storage containers and hand bags.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 showing a rear perspective view of an embodiment of the invention.

FIG. 2 showing a front perspective view of an embodiment of the invention.

FIG. 3 showing a front perspective view of the invention inverted.

FIG. 4 showing a front perspective view of the invention being used by an infant.

FIG. 5 showing a front view of the invention holding food.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

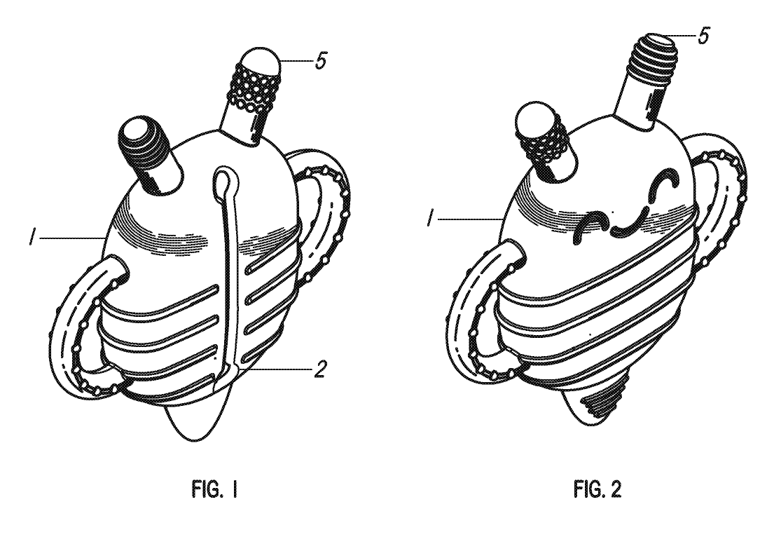

FIG. 1 showing a rear perspective view of an embodiment of the invention 1. The aforementioned invention comprised of, but not limited to; a hollow, elliptical-shaped puck having a plurality of decorative, molded adornments 5 such as arches, handles, rings, nibs etc. on an external surface. The invention 1 being of a size that can be received by an infant's mouth therein. Said invention 1 also being made of a flexible, yet rigid material, such as but not limited to; silicone, rubber and the like and having a slot 2 on one face extending along the longitudinal axis of the invention 1 creating a hollow cavity therein.

FIG. 2 showing a front perspective view of an embodiment of the invention having the aforementioned adornments 5. The figure showing the invention having the shape of a bee. However, other embodiments of the invention may have other shapes including, but not limited to: snails, fish, animals, other insects and the like.

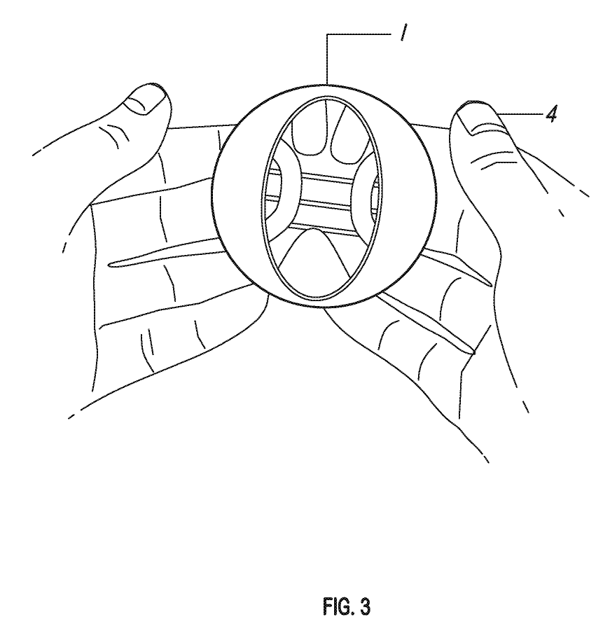

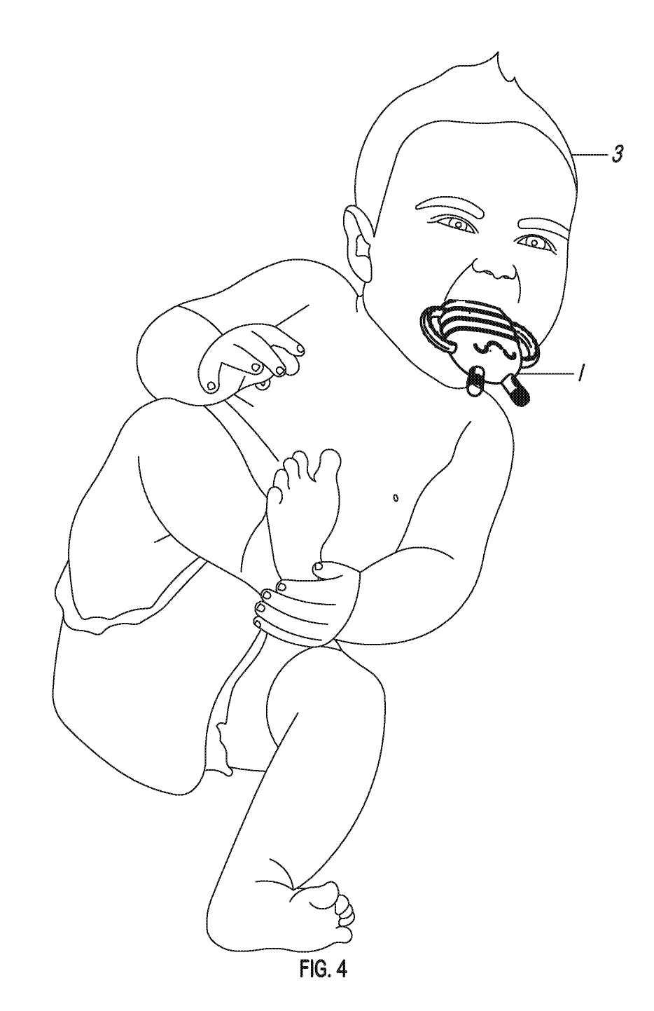

FIG. 3 showing a front perspective view of the invention 1 inverted by a user 4.

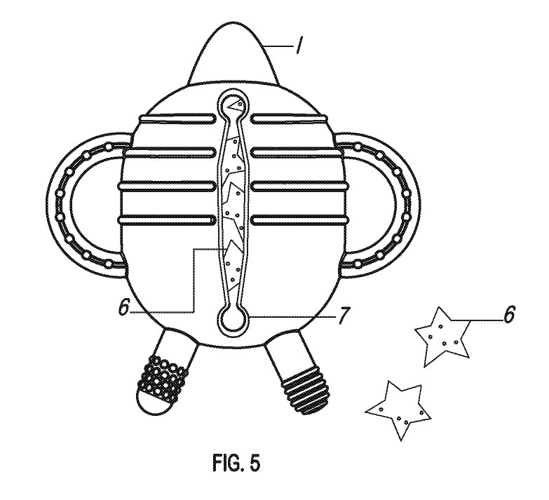

FIG. 4 showing a front perspective view of the invention 1 being used by an infant 3.

FIG. 5 showing a front perspective view of the invention 1 holding small food items 6 inside the cavity 7.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. An infant teether comprising:
a graspable housing defining a cavity therein; and
a teething portion defining a teething surface spanning a limited extent of the graspable housing.
